(19) United States
(12) Patent Application Publication
(10) Pub. No.: US 2009/0187514 A1
(43) Pub. Date: Jul. 23, 2009

(54) INTERACTIVE WEB BASED EXPERIENCE VIA EXPERT RESOURCE

(76) Inventors: Chris Hannan, Los Angeles, CA (US); Clark Pierce, Los Angeles, CA (US)

Correspondence Address: Cantor Colburn LLP - Fox Entertainment Group, 20 Church Street, 22nd Floor, Hartford, CT, 06103, US

(21) Appl. No.: 12/356,764

(22) Filed: Jan. 21, 2009

Related U.S. Application Data
(60) Provisional application No. 61/011,694, filed on Jan. 17, 2008.

(51) Int. Cl. G06F 17/20; G06N 5/02

(52) U.S. Cl. 706/11; 706/60; 704/9

(57) ABSTRACT

A system providing an interactive web based experience via an expert resource is provided. In this system, virtual experts field questions from end users, letting the users have control over an information-on-demand experience.

### CROSS REFERENCE TO RELATED APPLICATIONS

The present application claims priority to U.S. Provisional Patent Application Ser. No. 61/011,694 filed Jan. 17, 2008, the entire contents of which are specifically incorporated by reference herein.

### BACKGROUND

End users look to the media for guidance on just about every contemporary topic. Whether the users are looking for movie guides, commentary on television airings, commentary on contemporary events, or guidance on fantasy football prior to particular games, users will seek out the information either during scheduled television runs, or on the Internet.

The way in which the information is served to the user varies by media type. For television, scheduled or recurring reports are aired for the topic. For the Internet, a similar thing is done. Reports are generated by the content providers and served via video clip, text report, etc.

The common factor in any of the above is that the broadcaster or content provider packages the experience prior to delivery. That is, the content is chosen by the broadcaster or content provider. This is particularly true for experts, e.g., Larry King giving a report on the political landscape or Matthew Berry giving a report on fantasy football, wherein the reports are packaged and delivered as reports by the content providers.

The marketplace would greatly benefit from a more dynamic or interactive method of delivering such content.

### SUMMARY

The above described and other disadvantages of the prior art are overcome and alleviated by the presently described interactive web based experience via expert resource. In this system, virtual experts field questions from end users, letting the users have control over an information-on-demand experience.

For example, in an exemplary embodiment, the present system provides an interactive, one-to-one data exchange between a simulated expert on a network sports web page and an Internet user. The system contemplates incorporation of name talent as a SIM (simulated character) or ICON (representative character) who can appeal to the Internet users. Thus, information is not just provided to the user on demand, it is provided by a recognizable expert that the user trusts in a way that the user chooses.

In exemplary embodiments, the interviewee content is responsive to contemporary matters (e.g., fantasy football picks of the week or game, responsive answers about nascar or NASCAR events, or responsive answers to current election events, etc.). In other exemplary embodiments, the interviewee subject matter is periodically refreshed, e.g., each week or each day or part of a day, to keep pace with contemporary matters.

### BRIEF DESCRIPTION OF THE DRAWINGS

Referring now to the drawings, wherein like elements are numbered alike in the following FIGURES:

FIG. 1 is an exemplary expert and category selection user interface;

FIG. 2 is an exemplary expert interview interface;

FIG. 3 is another view of the exemplary expert interview interface of FIG. 2; and

FIG. 4 is another view of the exemplary expert interview interface of FIG. 2.

### DETAILED DESCRIPTION

Reference will now be made in detail to exemplary embodiments, examples of which are illustrated by the accompanying drawings. As indicated above, the presently described interactive web based experience provides a system wherein virtual experts field questions from end users, letting the users have control over an information on demand experience.

The details described below relate to a specific example, interactive expert interviewing in sports. However, it should be recognized that the below is only an example. The system described herein places emphasis on end user fulfillment, regardless of the platform. Indeed, the present system for providing information on demand via expert interviews may span across various platforms, including without limitation, sports, entertainment, film, interactive TV, reality TV, news, education, etc., where users may define their own experience by asking experts questions.

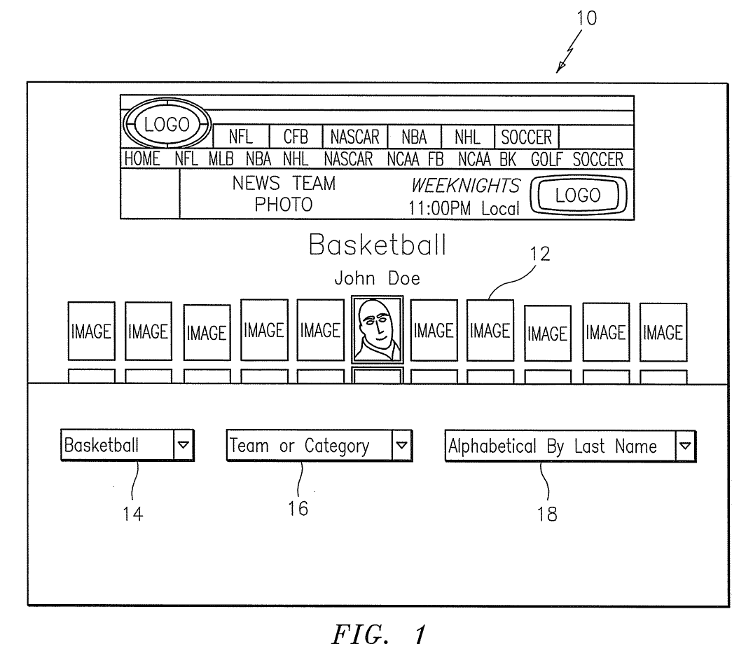

Referring now to FIG. 1, an exemplary virtual interview screen, shown generally at 10, provides a selection tool, shown as a set of scrolling thumbnails 12, for expert interviews. A sports drop down tab 14 provides a selection of different sports, e.g. basketball, football, etc. Selection of a particular sport changes the set of experts. Drop down tabs 16 and 18 allow further filtering of the available experts, e.g., according to team, category or provide selection of experts according to an alphabetical listing.

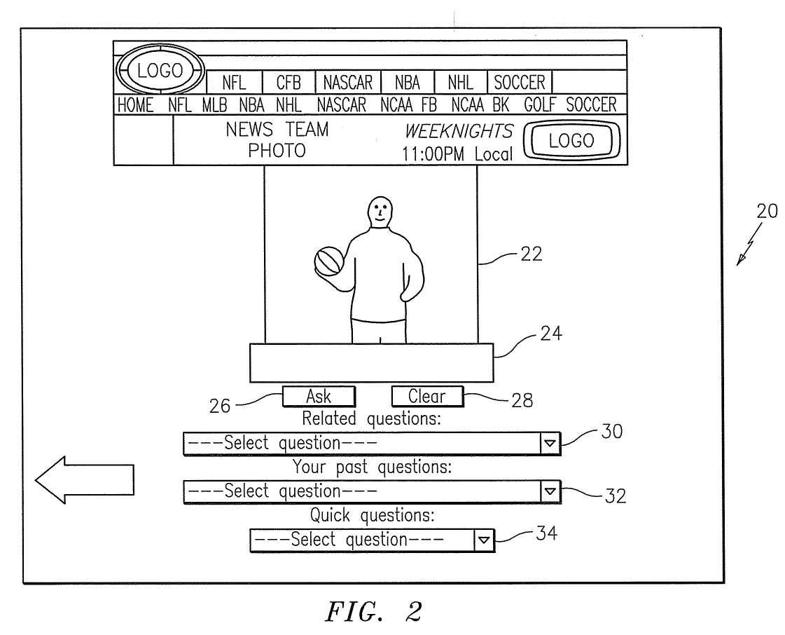

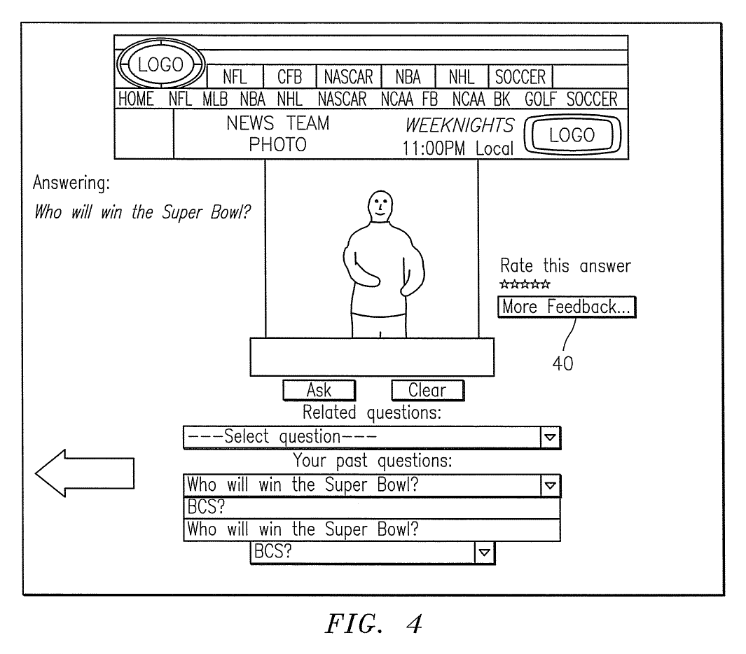

Referring now to FIG. 2, selection of a desired thumbnail (in this case John Salley) provides an exemplary interview screen 20. The interview screen 20 includes a window 22 in which video of John Salley's interview is displayed, a text entry window 24 for questions for John Salley, and ask and clear tabs 26, 28. Drop down menus are also provided for related questions 30 (recommended as related to an earlier asked question), a history of past questions 32 (also see FIG. 4 for an illustration of the drop down), and quick questions 34 (a selection of pre-constructed or popular questions).

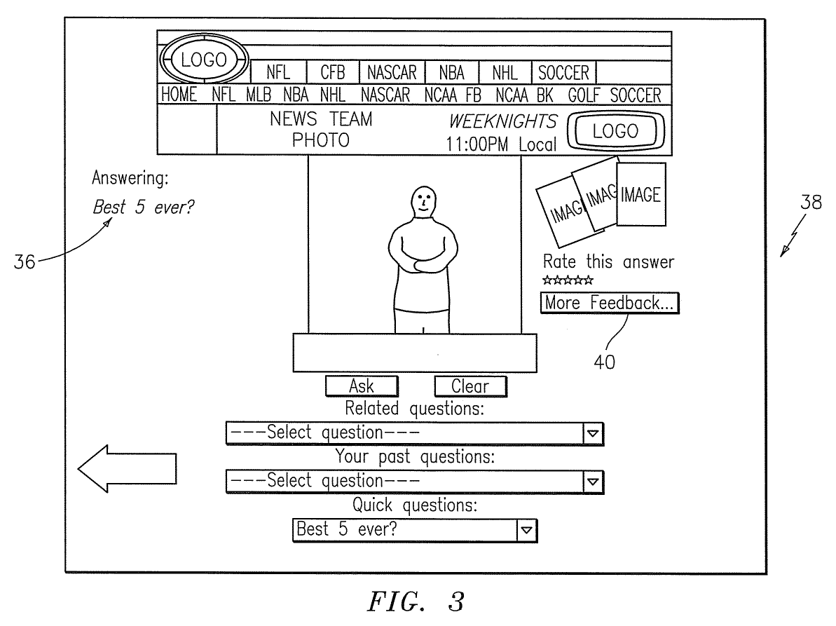

Referring now to FIG. 3, an exemplary area 36 is defined for identifying the question being answered by the expert. Another area 38 may be provided for information relevant to the expert's answer, e.g., pop-ups of basketball players the expert considers to be with the top five players ever, charts, statistics, etc. An example of an area for a user rating for the answer or other feedback is illustrated at 40.

The above-illustrated and described exemplary embodiment provides an interactive, one-to-one data exchange between a basketball expert on a network sports web page and an Internet user. Using this system, information is not just provided to the user on demand, it is provided by a recognizable expert that the user trusts. While the image illustrates a video of John Salley, the presently described system contemplates incorporation of the expert, name talent, etc. as a SIM (simulated character) or ICON (representative and identifiable character) who can appeal to the Internet users. Also, while a flash-based (Adobe Flash) page is illustrated, any environment allowing interaction between the user and the represented expert is contemplated.

With regard to generation of a database of expert answers, in an exemplary embodiment, the expert is recorded answering a list of predetermined questions in a studio production shoot. The answers are then edited to individual files in a non-linear editing system and indexed to create a simulated interview session responsive to entered questions by the user. The predetermined questions may be updated in an ongoing fashion to keep pace with and to provide comment on contemporary issues (always providing fresh commentary). Any other convenient method of recording or generating expert answers is also contemplated herein.

In another exemplary embodiment, responses may be selected from a plurality of experts, depending on the type of question asked. For example, a U.S. Senator in office could field a question about the U.S. Senate, while a relevant candidate could field a question about an election. Thus, a user may select a group of experts to interview (e.g., a political panel), the system may automatically select an expert, or the system may select from a user-defined group of experts.

The above describes a system that can provide thorough, character driven and informative interactive web experience where end users can ask questions to industry experts about their favorite category or topic with a visual and audible response. This solution provides a web experience that allows for updating and refreshing of topics to provide a unique user defined enhanced web experience. While current TV and web experience only provides the information that the broadcasters choose, this system provides an end user with a chance to ask experts the questions they want answered.

It will be apparent to those skilled in the art that, while exemplary embodiments have been shown and described, various modifications and variations can be made to the interactive web based experience via expert resource system disclosed herein without departing from the spirit or scope of the invention. Accordingly, it is to be understood that the various embodiments have been described by way of illustration and not limitation.

What is claimed is:

1. An interactive web-based expert interview system, comprising:
an indexed database of expert answers to questions; and
a user interface providing a simulated interview with said expert, the interface accepting end user questions, selecting relevant expert answers, and delivering said relevant expert answers to said end user.

2. The interactive web-based expert interview system of claim 1, wherein the expert answers relate to contemporary matters.

3. The interactive web-based expert interview system of claim 2, wherein the expert answers are updated at least monthly to keep pace with contemporary matters.

4. The interactive web-based expert interview system of claim 2, wherein the expert answers are updated at least weekly to keep pace with contemporary matters.

5. The interactive web-based expert interview system of claim 2, wherein the expert answers are updated at least daily to keep pace with contemporary matters.

6. The interactive web-based expert interview system of claim 2, wherein the expert answers relate to sporting events.

7. The interactive web-based expert interview system of claim 2, wherein the expert answers relate to fantasy football statistics, predictions or picks.

8. The interactive web-based expert interview system of claim 2, wherein the expert answers relate to NASCAR events.
